(19) United States
(12) Patent Application Publication
(10) Pub. No.: US 2008/0092631 A1
(43) Pub. Date: Apr. 24, 2008

(54) Poisonous Gas Detector

(76) Inventor: B.b Griswold, Chicago, IL (US)

Correspondence Address: Heather A. Kartsounes, Suite 2 North, 661 W. Lake St., Chicago, IL, 60661, US

(21) Appl. No.: 11/872,590

(22) Filed: Oct. 15, 2007

Related U.S. Application Data
(60) Provisional application No. 60/829,454, filed on Oct. 13, 2006.

(51) Int. Cl. G01N 7/00

(52) U.S. Cl. 73/31.05

(57) ABSTRACT

This invention relates to a device for detecting poisonous gas comprising a means for detecting poisonous gas and a means for automatically triggering an opening for air exchange. In levels of a poisonous gas reach a predetermined dangerous level, then the means for automatically triggering an opening for air exchange will be activated allowing for the exchange of clean air.

### FIELD OF INVENTION

This invention relates to a poisonous gas detector. More specifically, this invention relates to a device that detects poisonous gas and automatically opens a door, window, or other opening to release the gas and exchange it with clean, safer air.

### BACKGROUND OF INVENTION

Poisonous gas, especially carbon monoxide, can be a serious problem in a home. In cases of a leak into the home, victims who are exposed to this gas may experience a variety of health issues that, in serious cases, can cause brain damage or death. Carbon monoxide is an odorless and colorless gas that often times victims are not aware that they are subject to poisoning until it is too late. Because of this problem, carbon monoxide detectors have been developed to notify victims of its presence around them.

These detectors are particularly useful inside of a home where there should be very little carbon monoxide and these detectors can sense even small amounts in the air notifying someone of its presence. However, there are some parts of the home, like the garage or boiler rooms in basements where carbon monoxide from vehicles or furnaces is almost always present. This is generally cleared from the garage each time the garage door is lifted and the air can be exchanged. It is cleared from basements by a proper ventilation system.

Even though the poisonous gas can be easily cleared from the garage, there are many cases each year regarding people suffering from carbon monoxide poisoning in their garage. Usually it is someone working on their vehicle with the door closed to keep out hot or cold weather or it is children playing in the garage and cars. This invention solves the problem of carbon monoxide causing poisoning by utilizing an automatic detector and release of the garage door upon detection of high levels of poisonous gas.

In the case of poisonous gas in basements or other areas where a furnace or perhaps a stove is present and leaking gas, this invention can detect the gas and automatically open a window to release the gas and exchange it for cleaner and safer air.

### SUMMARY OF INVENTION

This invention relates to a device for detecting poisonous gas comprising a means for detecting said poisonous gas and a means for opening a door or in certain instances a window.

In a garage door setting, the means for detecting poisonous gas is to be linked with the means for opening the garage door. Once skilled in the art will recognize that linking the means for detecting poisonous gas with the means for opening a door can comprise a variety of physical embodiments. They can be linked in one central unit or may be linked between two separate and distinct units. For purposes of describing this invention, it will be assumed that they are linked within one unit.

The device for detecting poisonous gas will be set to detect dangerous levels of gas. The programming can be pre-programmed at the manufacturer's level or can be programmed at the end user's level. Once the means for detecting poisonous gas has sensed that the level of gas present has reached the dangerous level, the means for opening the door will be automatically activated and the door will open releasing the poisonous gas.

One skilled in the art will recognize that this device may be newly installed or retro-fitted into a garage door setting. The device will allow for normal usage of the garage door but will have the added security of an automatic release in cases where the poisonous gas levels become too high.

In basement or boiler room settings or in an area of the home near any other device that has potential to leak dangerous levels of gas, this device may be fitted to a window. The window may still be opened in a normal setting as a user desires, but may also be set to release when a level of poisonous gas may be released.

Other advantages and aspects of the present invention will become apparent upon reading the following description of the drawings and the detailed description of a preferred embodiment of the invention.

### DETAILED DESCRIPTION OF THE FIGURES

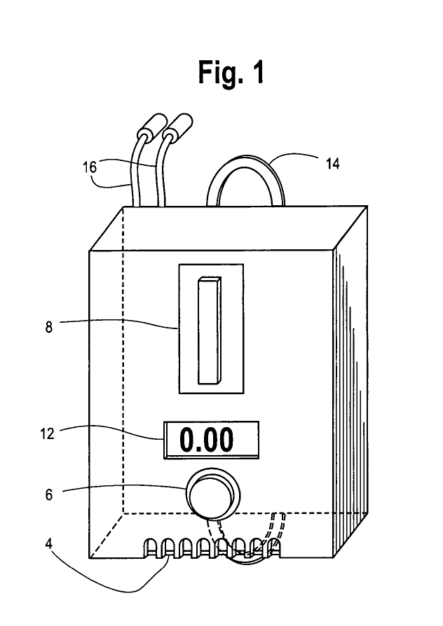

FIG. 1 depicts the poisonous gas detector as a complete unit.

### DETAILED DESCRIPTION OF THE PREFERRED EMBODIMENT

This invention relates to a device for detecting poisonous gas comprising a means for detecting poisonous gas 4 and a means for automatically triggering an opening for air exchange 6. The means for detecting poisonous gas 4 and the means for triggering an opening for air exchange 6 may be linked together or may be one unit. As seen in FIG. 1, a preferred embodiment is as one unit 10.

The means for triggering an opening for air exchange 6 may comprise of a garage door opener 8. The opening for air exchange may be a garage door in one preferred setting.

The garage door opener 8 can operate normally to open or close a door, such as in the garage setting where automatic opening and closing of door is widely preferred over a manual process. However, when paired with a means for detecting poisonous gas 4, the garage door opener 8 can be triggered to open if the means for detecting poisonous gas 4 senses dangerous levels of poisonous gas.

If this unit 10 detects a dangerous level of poisonous gas through its means for detecting poisonous gas, then means for automatically triggering an opening for air exchange 6 are activated and clean fresh air is allowed to circulate and disperses the poisonous gas.

The unit 10 may also comprise a reader 12 which indicates the level of poisonous gas that may be present. This reader 12 can help a user to watch levels before a dangerous situation is reached and can take steps to prevent levels of poisonous gas.

The unit 10 may be mounted to the wall via a hook 14 or other fastener. The unit 10 may run off of battery power or may be powered through wiring 16 directly into a structure.

It will be appreciated by those skilled in the art that many modifications and variations may be made to the embodiments described herein without departing from the spirit and scope of the invention.

What is claimed is

1. A device for detecting poisonous gas comprising
a means for detecting said poisonous gas; and
a means for automatically triggering an opening for air exchange.

2. A device for detecting poisonous gas as in claim 1 wherein said means for detecting said poisonous gas is connected to said means for automatically triggering an opening for air exchange.

3. A device for detecting poisonous gas as in claim 1 wherein said opening within said means for automatically triggering an opening for air exchange is a garage door.

4. A device for detecting poisonous gas as in claim 1 wherein said means for triggering an opening for air exchange is a garage door opener.

5. A device for detecting poisonous gas as in claim 2 wherein said means for triggering an opening for air exchange is activated by detection of certain levels of gas by said means for detecting poisonous gas.

6. A device for detecting poisonous gas as in claim 5 wherein said means for detecting levels of poisonous gas can be programmed to activate said means for triggering an opening for air exchange at certain levels.

7. A device for detecting poisonous gas comprising
a means for detecting said poisonous gas; and
a means for opening a window.

8. A device for detecting poisonous gas as in claim 7 wherein said means for detecting said poisonous gas is connected to a means for opening said window.

9. A device for detecting poisonous gas as in claim 8 wherein said means for opening said window is activated by detection of certain levels of gas by said means for detecting poisonous gas.

10. A device for detecting poisonous gas as in claim 9 wherein said means for detecting levels of poisonous gas can be programmed to activate said means for opening said window at certain levels.
